(19) United States
(12) Patent Application Publication
(10) Pub. No.: US 2008/0297930 A1
(43) Pub. Date: Dec. 4, 2008

(54) SECURITY REAR-VIEW MIRROR FOR THE OPENING OF THE VEHICLE REAR DOOR

(76) Inventor: Luis ROS SANTASUSANA, Barcelona (ES)

Correspondence Address: GOTTLIEB RACKMAN & REISMAN PC, 270 MADISON AVENUE, 8TH FLOOR, NEW YORK, NY, 10016-0601, US

(21) Appl. No.: 12/132,744

(22) Filed: Jun. 4, 2008

(30) Foreign Application Priority Data
Jun. 4, 2007 (ES) 200701197

(51) Int. Cl. B60R 1/08; B60R 1/04

(52) U.S. Cl. 359/883

(57) ABSTRACT

Security rearview mirror for the opening of the vehicle rear door, set to show the outer, side and back area of a car while proceeding with the opening of the rear door by the occupant of the back part of the vehicle.

### OBJECT OF THE INVENTION

The present invention relates to a security rear-view mirror for the opening of the vehicle rear door.

### FIELD OF THE INVENTION

Is the manufacture of vehicle accessories and complements, and especially of security parts for use in said vehicles.

### BACKGROUND OF THE INVENTION

It is known that during unwanted opening of a vehicle rear door, like due to a negligence, approaching of another vehicle can occur (for example of a motorcycle or a bicycle, etc.) with a high speed, so there is no time to close the door or reduce the speed of the approaching vehicle. Such situation can cause possible accident.

### BRIEF DESCRIPTION OF THE INVENTION

The invention relates to a device being arranged inside of a car (such as a sedan type) and more specifically next to the joint areas of each rear door, which allows to check whether the opening of these is safely verified before possible incidents with other vehicles at the rear and side section of the same.

Said device consists in a rear-view mirror which can be preferably mounted on each of the intermediate pillars forming part of the body of a car. This way the user leaving the car through a rear door is able to perceive the possible approach of other car and in such situation to delay the opening of the door of interest.

In order to facilitate the explanation of the invention, embodiments of a security rear-view mirror for the opening of the vehicle rear door according to the appended claims will now be described by way of non-restrictive examples and with reference to the accompanying drawings.

### BRIEF DESCRIPTION OF THE DRAWINGS

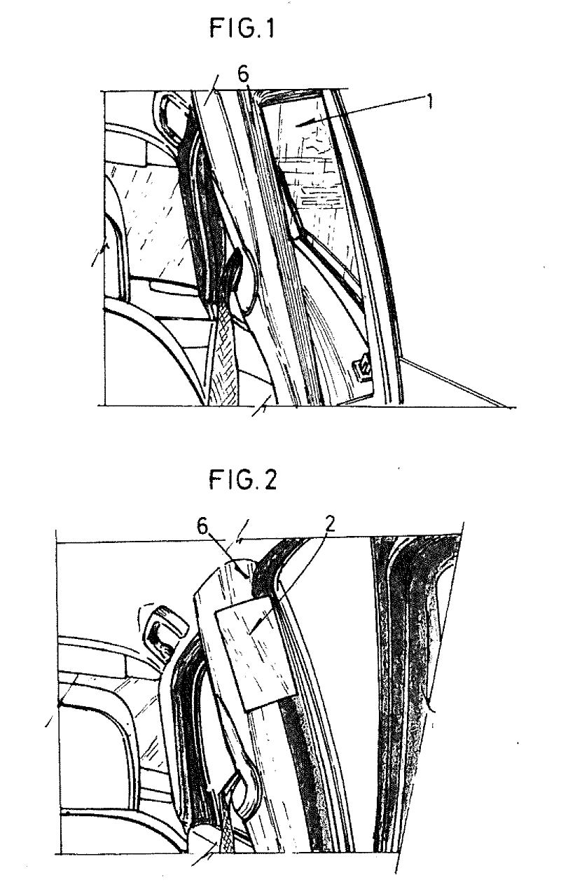

The FIGS. 1 and 2 show the installation of a new rear-view mirror in two different ways onto the inner right pillar of the passenger vehicle.

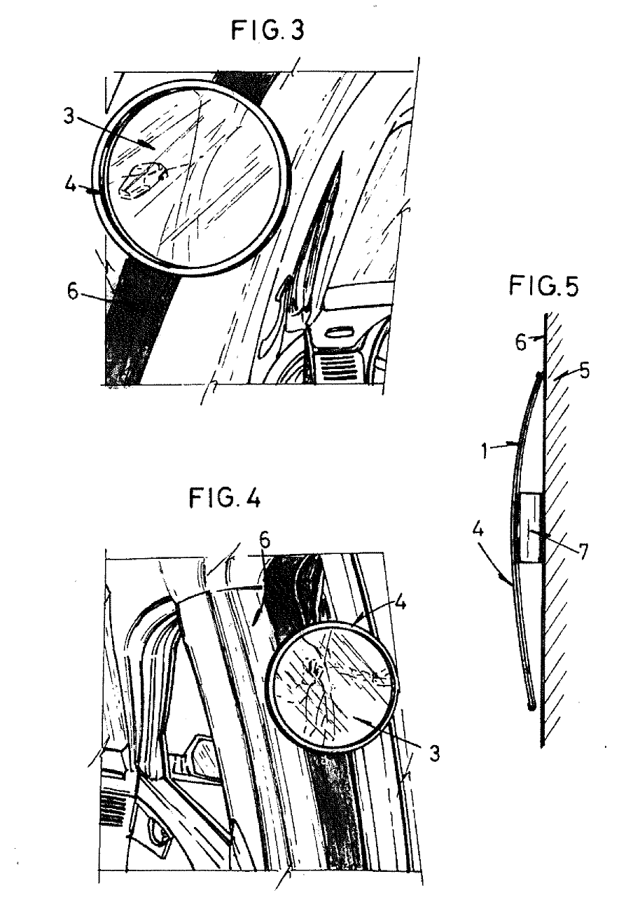

The FIGS. 3 and 4 show other form of a rear-view mirror of the described type, arranged on the same right pillar of the vehicle.

The FIG. 5 shows the way of mounting of a rear-view mirror, in a particular case, having the form of the fastening surface.

### DETAILED DESCRIPTION OF THE INVENTION

The elements designated with numerical indications from the drawings correspond to the following parts.

The new rear-view mirror consists in a convex or flat mirror, set to reflect a large area of one of the sides of the vehicle. It can have rectangular, significantly elongated (1, FIG. 1) or less elongated shape (2, FIG. 2) or just circular shape (3, FIGS. 3 and 4), and comprise an outer frame 4, like in said circular version, or lack it, like it has been shown on the FIGS. 1 and 2.

Assembly of the rear-view mirror can be carried out on each of the pillars 5 of the body of a car and more specifically in its inner and rear parts, where normally there exists a covering moulding 6, which can be either of a regular form having flat and aligned inner surface or of an irregular form having the surface with reliefs or differentiated areas.

Fastening of the rear-view mirror is carried out depending on the type of the moulding finish covering the pillar of interest.

In case of a regular moulding, fastening can be carried out by means of a self-adhesive tape on its both sides: one of them applied on the back of the mirror and the other one on the moulding surface. It can also be used a fastening tape of a velcro type or similar.

In case of an irregular moulding, there can be used an element 7 arranged between the mirror and the pillar, consisting of a plug or a block made of a rigid or semi-rigid material, having its both sides provided, respectively, with one self-adhesive material and one velcro system or similar.

Assembly system as described above allows to place the rear-view mirror in the most convenient site of the fastening pillar and logically it does not affect the opening and closing of the door of interest.

It is understood that geometric form, dimensions and materials of the described device can be selected form any convenient ones depending on each type and model of the vehicle.

The device or the mirror, can be integrated or form a part of the moulding of the inner side (6) of each of the side pillars (5) of the body of a vehicle.

1. Security rear-view mirror for the opening of the vehicle rear door, set to show the outer, side and back area of a car while proceeding with the opening of the rear door, characterized in that it consists in a rigid body (1), preferably having laminar warped shape and with one of its sides being reflective defining a mirror having a wide vision angle, which can be fitted onto an inner side (6) of each of the side pillars (5) of the body of the vehicle, providing an occupant of the back part of the vehicle with a view of outer and back area prior to the opening of a rear door.

2. Device according to claim 1, characterized in that said device shows regular geometric shape, such as rectangular (1, 2) and circular (3), having an outer frame (4), and non-functional side on its back provided with the mounting means for a moulding (6) associated with the inner pillar (5) of the vehicle.

3. Device according to claim 2, characterized in that the mounting means of the body (1) to the inner pillar of the vehicle preferably consist in a laminar element self-adhesive on its both sides and of reversible use.

4. Device according to claim 2, characterized in that the mounting means of the body (1) to the inner pillar (5) of the vehicle consist in a block (7) made of a semi-rigid material having both of its sides covered by a self-adhesive material, set for its application onto a moulding (6), having irregular surface, of the corresponding pillar (5).

5. Device according to claim 1, characterized in that the rigid body (1) is convex.

6. Device according to claim 1, characterized in that the rigid body (1) is flat.
